(19) United States
(12) Patent Application Publication
(10) Pub. No.: US 2014/0267606 A1
(43) Pub. Date: Sep. 18, 2014

(54) Systems and Methods for Time Encoding and Decoding Machines

(71) Applicant: The Trustees of Columbia University in the City of New York, New York, NY (US)

(72) Inventors: Aurel A. Lazar, New York, NY (US); Yevgeniy B. Slutskiy, Brooklyn, NY (US); Yiyin Zhou, Shanghai (CN)

(73) Assignee: The Trustees of Columbia University in the City of New York, New York, NY (US)

(21) Appl. No.: 14/216,255

(22) Filed: Mar. 17, 2014

Related U.S. Application Data
(60) Provisional application No. 61/798,722, filed on Mar. 15, 2013.

(51) Int. Cl. H04N 13/00

(52) U.S. Cl. CPC H04N 13/0048
USPC 348/43

(57) ABSTRACT

Systems and methods for system identification, encoding and decoding multi-component signals are disclosed. An exemplary method can include receiving the one or more multi-component signals and separating the multi-component signals into channels. The method can also filter each of the channels using receptive field components. The values for the receptive field components can be aggregated and provided to neurons for encoding.

### CROSS-REFERENCE TO RELATED APPLICATIONS

This application is related to U.S. Provisional Application Ser. No. 61/798,722, filed on Mar. 15, 2013, which is incorporated herein by reference in its entirety and from which priority is claimed.

### STATEMENT REGARDING FEDERALLY-SPONSORED RESEARCH

This invention was made with government support under Grant No. FA9550-12-1-0232 awarded by the Air Force Office of Scientific Research. The government has certain rights in the invention.

### BACKGROUND

The disclosed subject matter relates to techniques for system identification, encoding and decoding multi-component signals.

To analyze the sensory world, for example the sensation of light, neurons can be used to represent and process external analog sensory stimuli. Similar to analog-to-digital conversion which converts analog signals so that they can be read by computers, the sensory inputs can be transformed into neural codes (for example spikes) when subject to stimuli by encoding. Decoding can be used to invert the transformation in the encoding and reconstruct the sensory input when the sensory system and the outputs are known. Decoding can be used to reconstruct the stimulus that would have generated the observed spike trains based on the encoding procedure of the system.

When multi-component signals are processed, channels, for example color channels, can be stored, transmitted, and decoded separately. Moreover, stereoscopic (3D) videos can include two separate video streams, one for the left eye and the other for the right eye. However, the representation of stereoscopic video does not necessarily require two separate encoders. Most of the existing encoding and decoding techniques do not take into account the variety of color representation in a sensory system. There exists a need for an improved method of performing encoding and decoding of multi-component signals to effectively encode and reconstruct the stimuli.

### SUMMARY

Systems and methods for system identification, encoding and decoding multi-component signals are disclosed herein.

In one aspect of the disclosed subject matter, techniques for encoding multi-component signals are disclosed. An exemplary method can include receiving the one or more multi-component signals and separating the multi-component signals into channels. The method can also filter each of the channels using receptive field components. The outputs of the receptive field components can be aggregated and provided to neurons for encoding.

In some embodiments, the method can include encoding the aggregated sum of the outputs of receptive field components into spike trains. In some embodiments, the channels can be modeled into monochromatic signals. In other embodiments, the multi-component signals can be modeled using vector-valued tri-variable trigonometric polynomial space.

In one aspect of the disclosed subject matter, techniques for decoding multi-component signals are disclosed. An exemplary method can include receiving encoded signals and modeling the encoding as sampling on the signals. The method can further include determining the form of reconstruction for the output signals. The method can also further reconstruct such output signals.

Systems for encoding multi-component signals are also disclosed. In one embodiment, an example system can include a first computing device that has a processor and a memory thereon for the storage of executable instructions and data, wherein the instructions are executed to encode the multi-component signals.

### BRIEF DESCRIPTION OF THE DRAWINGS

FIG. 1A illustrates an exemplary system in accordance with the disclosed subject matter.

FIG. 1B illustrates an exemplary Time Encoding Machine (TEM) in accordance with the disclosed subject matter.

FIG. 1C illustrates an exemplary Time Decoding Machine (TDM) in accordance with the disclosed subject matter.

FIG. 1D illustrates an exemplary block diagram of an encoder unit that can perform encoding on color signals in accordance with the disclosed subject matter.

FIG. 1E illustrates an exemplary detailed block diagram of the encoder unit that can perform encoding on color signals in accordance with the disclosed subject matter.

FIG. 2 illustrates an exemplary block diagram of a decoder unit that can perform decoding on encoded signals in accordance with the disclosed subject matter.

FIG. 3 illustrates an exemplary block diagram of an encoder unit that can perform encoding on more than one input of colors signals in accordance with the disclosed subject matter.

FIG. 4 illustrates an exemplary method of encoding on more than one inputs of colors signals in accordance with the disclosed subject matter.

FIG. 5 illustrates an exemplary method of decoding on more than one input of encoded signals in accordance with the disclosed subject matter.

FIG. 6 illustrates an exemplary embodiment of encoding neural circuit for color visual stimuli in accordance with the disclosed subject matter.

FIG. 7 illustrates an exemplary block diagram of an Integrate-and-fire (IAF) neuron in accordance with the disclosed subject matter.

FIG. 8 illustrates an exemplary embodiment of a color video Time Decoding Machine in accordance with the disclosed subject matter.

FIG. 9 illustrates an exemplary snapshot of the original color video and reconstructed video in accordance with the disclosed subject matter.

FIG. 10 illustrates an exemplary snapshot of all three channels of the corresponding time instant in FIG. 9 in accordance with the disclosed subject matter.

FIG. 11 illustrates an exemplary block diagram of functional identification with multiple trials of controlled videos in accordance with the disclosed subject matter.

FIG. 12A and FIG. 12B illustrate an exemplary receptive field in accordance with the disclosed subject matter.

FIG. 13A, FIG. 13B, and FIG. 13C illustrate exemplary effect of number of video clips and total number of measurements on the quality of identification in accordance with the disclosed subject matter.

FIG. 14A and FIG. 14B illustrate exemplary spikes in accordance with the disclosed subject matter.

FIG. 15 illustrates an exemplary SNR of the identified receptive fields over the original receptive fields in accordance with the disclosed subject matter.

FIG. 16 illustrates an exemplary block diagram of a massively parallel neural circuit for encoding stereoscopic video in accordance with the disclosed subject matter.

FIG. 17 illustrates an exemplary snapshot of the original video, the reconstructed video and the error in accordance with the disclosed subject matter.

FIG. 18 illustrates an exemplary snapshot of the original stereo video and the reconstructed in separate channels in accordance with the disclosed subject matter.

FIG. 19 illustrates an exemplary blog diagram of a massively parallel neural circuit for encoding stereoscopic color video in accordance with the disclosed subject matter.

FIG. 20 illustrates an exemplary snapshot of the original 3D color video and the reconstructed in accordance with the disclosed subject matter.

FIG. 21 illustrates an exemplary reconstruction of individual channels in accordance with the disclosed subject matter.

### DETAILED DESCRIPTION

Techniques for encoding and decoding one or more multi-component signals, and system identification of one or more multi-component signal encoding system are presented. An exemplary technique includes separating multi-component signals into channels, for example RGB color channels or components, performing linear operation on the color components, and encoding the output from the linear operation to provide encoded signals. The encoded signals can be spike trains. It should be understood that one example of system identification (or channel identification) can be identifying unknown receptive field components in an encoder unit.

In one embodiment, the multi-component can include color signals. In another embodiment, the multi-component signals can include black-and-white signals. In one example, the multi-component signals can include three-dimensional (3D) stereoscopic signals.

FIG. 1A illustrates an exemplary system in accordance with the disclosed subject matter. With reference to FIG. 1A, signals 101, for example multi-component signals, are received by an encoder unit 141, 143, and 145. In one example, the multi-component signals can include color signals. The encoder unit 199 can encode the input signals 101 and provide the encoded signals to a control unit or a computer unit 195. The encoded signals can be digital signals that can be read by a control unit 195. The control unit 195 can read the encoded signals, analyze, and perform various operations on the encoded signals. The encoder unit 141, 143, and 145 can also provide the encoded signals to a network 196. The network 196 can be connected to various other control units 195 or databases 197. The database 197 can store data regarding the signals 101 and the different units in the system can access data from the database 197. The database 197 can also store program instructions to run the disclosed subject matter. The system also consists of a decoder 231 that can decode the encoded signals, which can be digital signals, from the encoder unit 199. The decoder 231 can recover the analog signal 101 encoded by the encoder unit 199 and output an analog signal 215 accordingly.

For purposes of this disclosure, the database 197 and the control unit 195 can include random access memory (RAM), storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory. The control unit 195 can further include a processor, which can include processing logic configured to carry out the functions, techniques, and processing tasks associated with the disclosed subject matter. Additional components of the database 197 can include one or more disk drives. The control unit 195 can include one or more network ports for communication with external devices. The control unit 195 can also include a keyboard, mouse, other input devices, or the like. A control unit 195 can also include a video display, a cell phone, other output devices, or the like. The network 196 can include communications media such wires, optical fibers, microwaves, radio waves, and other electromagnetic and/or optical carriers; and/or any combination of the foregoing.

FIG. 1B illustrates an exemplary Time Encoding Machine (TEM) in accordance with the disclosed subject matter. It should be understood that a TEM can also be understood to be an encoder unit 199. In one embodiment, Time Encoding Machines (TEM) can be asynchronous nonlinear systems that encode analog signals into multi-dimensional spike trains. With reference to FIG. 1B, a TEM 199 is a device which encode analog signals 101 as monotonically increasing sequences of irregularly spaced times 147, 149, 152, 201. A TEM 199 can output, for example, spike time signals 147, 149, 152, 201, which can be read by computers.

FIG. 1C illustrates an exemplary Time Decoding Machine (TDM) in accordance with the disclosed subject matter. It should be understood that a TDM can also be understood to be a decoder unit 231. In one embodiment, Time Decoding Machines (TDMs) can reconstruct time encoded analog signals from spike trains. With reference to FIG. 1C, a TDM 231 is a device which converts Time Encoded signals 147, 149, 152, 201 into analog signals 215 which can be actuated on the environment. Time Decoding Machines 231 can recover the signal loss-free. In one example, a TDM can be a realization of an algorithm that recovers the analog signal from its TEM counterpart.

FIG. 1D illustrates an exemplary block diagram of an encoder unit 199 that can perform encoding on multi-component signals, for example, color signals 101 in accordance with the disclosed subject matter. With reference to FIG. 1D, analog signals 101 are received by the encoding unit 199. The analog signals 101 are then processed into different RGB channels 105, 107, 109. The output from the RGB channels 105, 107, 109 are then provided as an input to 191, which performs, for example, a linear operation on the input. This linear operation can be, for example, filtering each RGB channel and mixing those channels. The output from the linear operation 191 is then provided as an input to the neurons 141, 143, and 145. The neurons 141, 143, and 145 perform encoding on the input and the neurons 141, 143, and 145 output encoded signals 147, 149, and 151. An example of the encoded signals can be spike trains.

FIG. 1E illustrates an exemplary block diagram of the encoder unit 199 that can perform encoding on color signals 101 in accordance with the disclosed subject matter. With reference to FIG. 1E, analog signals 101 are received by the encoding unit 199. The analog signals are then sampled into different RGB channels 105, 107, 109. The output from the RGB channels 105, 107, 109 are then provided as an input to receptive field components 111, 113, 115, 117, 119, 121, 123, 125, 127. The receptive field components 111, 113, 115, 117, 119, 121, 123, 125, 127 can perform a linear operation on the input from the RGB channels 105, 107, 109. It should be understood that by filtering each RGB channel and mixing these channels at 129, 131, 133, each neuron 141, 143, 145 can effectively carry a mixed information from multiple channels, for example RGB color channels.

In one embodiment, a set of three receptive field components 111, 113, 115, 117, 119, 121, 123, 125, 127 are provided as input to one neuron 141, 143, 145. In one example, each receptive field component 111, 113, 115, 117, 119, 121, 123, 125, 127 will receive input from one of the RGB channels 105, 107, 109. The output of the set of receptive field components 111, 113, 115, 117, 119, 121, 123, 125, 127 is then summed 129, 131, 133 and the output of the summation 135, 137, 139 is provided as an input to the neurons 141, 143, 145. It should be understood that other mathematical processes can also occur on the outputs from the receptive field components 111, 113, 115, 117, 119, 121, 123, 125, 127. In one example, receptive field components 111, 113, 115 receive input from each of the RGB channels 105, 107, and 109. The output of the receptive field components 111, 113, 115 will be added and provided as an input to one of the neurons 141. The neurons 141, 143, 145 perform encoding processing on the inputs 135, 137, 139 and output encoded signals 147, 149, 152. The encoded signals 147, 149, 152 can be spike trains.

In some embodiments, the group of receptive fields (for example receptive fields 111, 113, 115) can be arranged as follows. One of receptive fields in the group (for example receptive field 111) can be assigned a non-zero value (for example, red, green, or blue) and the other receptive fields (for example 113 and 115) are assigned a zero value. In other embodiments, the group of receptive fields can be arranged as follows: For 3*N neurons, a pool of N receptive field components is created, which have a zero value (i.e. the receptive field components are not associated with any RGB color value). After creating the pool of N receptive field components, then 3N color receptive fields, each consists 3 receptive field components is constructed. To construct 3N color receptive fields, 3 out from the N receptive field components are picked. Then non-zero values (for example color values) are assigned to each of the three that are picked and the receptive fields are assigned to a neuron. For example, three receptive field components 111, 113, and 115 are picked. Then receptive field component 111 is assigned a non-zero value (for example a red component), receptive field component 113 is assigned a non-zero value (for example a blue component), and receptive field component 115 is assigned a non-zero value (for example a green component). 111, 113, and 115 are then assigned to Neuron 141. Then, to create receptive fields for neuron 143, a different combination for the receptive field components 117, 119, 121 can be used. For example: a non-zero value of blue component is assigned to 117, 119, 121. As such, in one example, if there are 3*3 neurons (where N=3), 27 (3 to the power of 3) possible combinations can be created and each combination can be assigned to a neuron. 9 of these 27 possible combinations can be picked and 9 of these combinations can be assigned to the RGB component receptive field of 9 neurons. The three of the N receptive field components that were first chosen can then be discarded and there will be N−3 left in the pool. This is repeated until there are no more receptive field components in the pool. This can enable one to create a total of color receptive fields for 3N neurons.

In another example, the neurons can be arranged by randomly assigning non-zero component values to the receptive field components.

FIG. 2 illustrates an exemplary block diagram of a decoder unit 231 that can perform decoding on encoded signals 147, 149, 152, 201 in accordance with the disclosed subject matter. With reference to FIG. 2, encoded signals 147, 149, 152, 201 are received by the decoding unit 231. The encoded signals 147, 149, 152, 201 are used to determine sampling 203 of the signals and corresponding measurements 205 using the time of the encoded signals 147, 149, 152, 201. Further calculations 207 can be performed on the sampling 203 of the signals. Coefficients 209 of the linear combination of the sampling are then calculated using the measurements 205 and the sampling 203 of the signals and 207 through solving a system of linear equations. The signal 215 is then reconstructed at 213 using the sampling 203 of the signal and the coefficients 209. In one embodiment, the decoder unit 231 can effectively reconstruct the signals and demix the signals back to the RGB channels.

FIG. 3 illustrates an exemplary block diagram of an encoder unit 199 that can perforin encoding on more than one input of colors signals 301, 303 in accordance with the disclosed subject matter. With reference to FIG. 3, in one embodiment, more than one inputs signals 301, and 303 are separated into different RGB channels 305, 307, 309, 311, 313, 315. The output from the RGB channels 305, 307, 309, 311, 313, 315 can then be, for example, mixed and provided as an input to the receptive field components 331. In one example, a set of the receptive field components 331 are provided as an input to one neuron 371, 373, 375, 377, 379, 381. For example, outputs of a set of six receptive field components 331 are summed 335, 337, 339, 341, 343, 345 and provided as an input 351, 353, 355, 357, 359, 361 to neuron 371. Each of the six receptive field components 331 receive input from the RGB channels 305, 307, 309, 311, 313, 315 and perform a linear operation on the RGB channels 305, 307, 309, 311, 313, 315. The neurons 371, 373, 375, 377, 379, 381 then process the input 351, 353, 355, 357, 359 received from the receptive field components 331. The neurons 371, 373, 375, 377, 379, 381 encode the input 351, 353, 355, 357, 359 received and output spike trains 391, 392, 393, 394, 395, 396.

FIG. 4 illustrates an exemplary method of encoding on more than one inputs of colors signals 101 in accordance with the disclosed subject matter. In one embodiment, this exemplary method can be performed by an encoder unit 199, a control unit 195, or a network 196. With reference to FIG. 4, in one embodiment, the encoder unit 199 receives color signals 101 (401). The color signals 101 are then separated into different RGB channels 105, 107, 109 (403). In one example, this can be performed by sampling the signals 101 into the different RGB channels 105, 107, 109. The method can further include providing the output from the RGB channels 105, 107, 109 into receptive field components 111, 113, 115, 117, 119, 121, 123, 125, 127. Each receptive field components 111, 113, 115, 117, 119, 121, 123, 125, 127 performs processing of linear operations on the input from the RGB channels 105, 107, 109. In one example, the linear operations can include filtering the color channels by the receptive field components 111, 113, 115, 117, 119, 121, 123, 125, 127 (405). The output of the linear operation by the receptive field components can be summed 129, 131, 133 and provided as input 135, 137, 139 to the neurons 141, 143, 145. The neurons 141, 143, 145 can then encode the inputs 135, 137, 139 into encoded signals 147, 149, 152. In one example, the output of the encoding by the neurons 141, 143, 145 can be spike trains (409).

FIG. 5 illustrates an exemplary method of decoding on more than one input of encoded signals 147, 149, 152, 201 in accordance with the disclosed subject matter. In one embodiment, this exemplary method can be performed by a decoder unit 231, a control unit 195, or a network 196. With reference to FIG. 5, in one embodiment, encoded signals 147, 149, 152, 201 are received by the decoding unit 231 (501). The encoded signals 147, 149, 152, 201 are used to determine a sampling 203 of the signals (503) and measurements 205 using the time of the encoded signals 147, 149, 152, 201 (505). More calculation 207 can be performed on the sampling 203 of the signals. Coefficients 209 of the linear combination of the sampling are then calculated using the measurements 205 and the sampling 203 of the signals and 207 (507). The processing in 207, for example, can be calculated using Equation 49. The method can then determine the reconstruction of the signal 215 (509). In one embodiment, the signal 215 is then reconstructed at 213 using the sampling 203 of the signals and the coefficients 209.

### EXAMPLES

For purpose of illustration and not limitation, exemplary embodiments of the disclosed subject matter will now be described. Some of the existing neural computation models can employ grayscale or monochrome stimuli to test and describe the computation performed by neural circuits of the visual system. The disclosed subject matter can model both synthetic and natural color stimuli. The following examples describe how both synthetic and natural grayscale stimuli can be modeled as elements of a scalar-valued well-known Reproducing Kernel Hilbert Space (RKHS). The examples then extend the space of stimuli to a vector-valued RKHS that can handle both color and stereoscopic visual stimuli. Due to space constraints, the examples discuss video stimuli only. However, images can be handled in a similar fashion.

### Example 1

### Modeling Color Visual Stimuli

In one example, the grayscale visual stimuli u=u(x, y, t)(x, y, t)ε [symbol] , can be modeled, as elements of an RKHS [symbol] . The elements of the space [symbol] can be scalar valued functions defined over the space-time domain [symbol] = [symbol] ₓ× [symbol] _{y}× [symbol] ₜ, where [symbol] ₓ=[0, Tₓ], [symbol] _{y}=[0, T_{y}], and [symbol] ₜ=[0, Tₜ], with Tₓ, T_{y}, Tₜγ [symbol] ₊. The scalar functions represent the intensity of light at a particular point in a two-dimensional space (x, y) at time t.

For practical and computational reasons, this example works with spaces of trigonometric polynomials. However, the disclosed subject matter can apply to many other RKHSs (for example, well-known Sobolev spaces and Paley-Wiener spaces, or the like).

Each element uε [symbol] is of the form

$$\begin{matrix}u ( x , y , t ) = {\sum }_{{l}_{x} = - {L}_{x}}^{{L}_{x}} {\sum }_{{l}_{y} = - {L}_{y}}^{{L}_{y}} {\sum }_{{l}_{t} = - {L}_{t}}^{{L}_{t}} {c}_{{l}_{x} {l}_{y} {l}_{t}} {e}_{{l}_{x} {l}_{y} {l}_{t}} ( x , y , t ) , \\ with & ( Equation 1 ) \\ {e}_{{l}_{x} {l}_{y} {l}_{t}} ( x , y , t ) = exp [ j ( \frac{{l}_{x} {Ω}_{x} x}{{L}_{x}} + \frac{{l}_{y} {Ω}_{y} y}{{L}_{y}} + \frac{{l}_{t} {Ω}_{t} t}{{L}_{t}} ) ] , & ( Equation 2 )\end{matrix}$$

where j denotes the imaginary number and Lₓ, L_{y}, Lₜ represent the order of the space H in each corresponding variable. In this example, the elements of [symbol] are periodic bandlimited functions with bandwidths Ωₓ, Ω_{y} and Ωₜ in space and in time, respectively. The period in each variable is associated with the space-time domain and is defined as:

$${T}_{x} = \frac{2 π {L}_{x}}{{Ω}_{x}} , {Y}_{y} = \frac{2 π {L}_{y}}{{Ω}_{y}} , {T}_{t} = \frac{2 π {L}_{t}}{{Ω}_{t}} . \qquad ( Equation 3 )$$

[symbol] is endowed with the inner product defined by

$${〈 u , w 〉}_{H} = \frac{1}{{T}_{x} {T}_{y} {T}_{t}} {\int }_{D} u ( x , y , t ) \overline{w ( x , y , t )} d x d y d t , \qquad ( Equation 4 )$$

where w̅ denotes the complex conjugate of w. The set of functions

$$\{ {e}_{{l}_{x} {l}_{y} {l}_{t}} \vert {l}_{x} = - {L}_{x} , … , {L}_{x} ; {l}_{y} = - {L}_{y} , … , {L}_{y} ; {l}_{t} = - {L}_{t} , … , {L}_{t} \}$$

can form an orthonormal basis in [symbol] . The reproducing kernel of [symbol] is a function given by K: [symbol] × [symbol] → [symbol] where

$$K ( x , y , t ; {x}^{′} , {y}^{′} , {t}^{′} ) = {\sum }_{{l}_{x} = - {L}_{x}}^{{L}_{x}} {\sum }_{{l}_{y} = - {L}_{y}}^{{L}_{y}} {\sum }_{{l}_{t} = - {L}_{t}}^{{L}_{t}} {e}_{{l}_{x} , {l}_{y} , {l}_{t}} ( x - {x}^{′} , y - {y}^{′} , t - {t}^{′} ) \qquad ( Equation 5 )$$

satisfies the reproducing property

[symbol]

u,K_{x,y,t} [symbol] =u(x,y,t), for all uε [symbol] , (Equation 6)

where K_{x,y,t}(x′, y′, t′)=K(x, y, t; x′, y′, t′). In one example, the RKHS [symbol] can be effective in modeling both synthetic and nature stimuli.

Color can be the perception of the wavelength of light. In this example, a discrete representation of wavelength is considered, which is naturally provided by multiple types of cone photoreceptors having different peak spectral sensitivities. For example, it is well known that the trichromacy in human vision arises as a result of the visual space being sampled by three different kinds of photoreceptors at the very first stage of the visual system. Specifically, the L-, M-, and S-cones of the retina can provide an initial representation of the visual space in terms of the red, green, and blue color channels, respectively. Subsequent processing within and across these color channels can afford enhanced scene segmentation, visual memory, as well as perception and recognition of objects and faces.

In this example, this concept can be extended to the space of color stimuli. A simple extension can be to assume that color visual stimuli are elements of vector-valued space of trigonometric polynomials. Each visual stimulus u is a vector-valued function u: [symbol] → [symbol] ³ of the form

u(x,y,t)=[u₁(x,y,t),u₂(x,y,t),u₃(x,y,t)]^{T}, (Equation 7)

where each of the component functions u₁ (red channel), u₂ (green channel) and u₃ (blue channel) is a scalar-valued function in the RKHS [symbol] . As the space, that is used in this example can be a direct sum of three orthogonal spaces [symbol] , this color visual stimulus space can be denoted as [symbol] ³. For simplicity of notation, in this example, the bandwidth is assumed that the order of each of the considered subspaces are the same. By construction, the space [symbol] ³ can be endowed with the inner product

$${〈 u , w 〉}_{{ℋ}^{3}} = {\sum }_{m = 1}^{3} {〈 {u}_{m} , {w}_{m} 〉}_{ℋ} \qquad ( Equation 8 )$$

RKHSs with vector-valued function elements have been studied in depth (see [24, 25] and reference within) and the reproducing kernel K: [symbol] × [symbol] →M(3, [symbol] ) of [symbol] ³, where M(3, [symbol] ) is the space of 3×3 matrices (bounded linear operators on [symbol] ³) is given by

$$K = [ \begin{matrix}{K}_{1} & 0 & 0 \\ 0 & {K}_{2} & 0 \\ 0 & 0 & {K}_{3}\end{matrix} ] . \qquad ( Equation 9 )$$

where Kₘ, m=1, 2, 3 are reproducing kernels of [symbol] as in (5). The reproducing property of [symbol] ³ is given by

[symbol]

u,K_{x,y,t}v [symbol] = [symbol] u(x,y,t),v) [symbol] , for all uε [symbol] ³ and vε [symbol] ³ (Equation 10)

where K_{x,y,t}vε [symbol] ³ and is defined as

K_{x,y,t}v=K(x,y,t;x′,y′,t′)v. (Equation 11)

From the above, for a unit vector eₘε [symbol] , m=1, 2, 3,

uₘ(x,y,t)= [symbol] u,K_{x,y,t}eₘ [symbol] . (Equation 12)

### Example 2

### Neural Encoding Circuits for Color Vision

In this example, the color visual stimuli discussed above can be encoded into a multidimensional sequence of spikes by a population of spiking neurons using the disclosed subject matter described in FIG. 1D, FIG. 1E, and FIG. 4. A massively parallel neural circuit is employed in this example consisting of thousands of neurons, in which each neuron can be a fundamentally slow device capable of producing only a limited number of spikes per unit of time. Under certain conditions, for example very natural conditions, the population of neurons as a whole can provide a faithful, or loss-free, representation of color visual stimuli in the spike domain.

FIG. 6 illustrates an exemplary embodiment of encoding neural circuit for color visual stimuli in accordance with the disclosed subject matter. FIG. 6 illustrates an example of a massively parallel neural circuit. The color visual stimulus u 601 consists of 3 components u₁, u₂, u₃, as in 605, 607, 609 (403). These components 605, 607, 609 (corresponding to the red 605, green 607, and blue 609 channel, respectively) are assumed, in this example, to be extracted by the photoreceptors and subsequently encoded by a population of N neurons. In this example, all neurons 641, 643, 645 receive information from each photoreceptor type and multiplex (mix) and encode that information into the spike domain (405, 407, 409). Specifically, each neuron i 641, 643, 645 is associated with a multi-component linear receptive field 611, 613, 615, 617, 619, 621, 623, 625, 627, or kernel, hⁱ (x,y,t), where

hⁱ(x,y,t)=[h₁ⁱ(x,y,t),h₂ⁱ(x,y,t),h₃ⁱ(x,y,t)]^{T}. (Equation 13)

In this example, the components hₘⁱ(x, y, t), m=1, 2, 3, i=1, . . . , N, are assumed to be causal in the time domain [symbol] ₜ and have a finite support in the spatial domains [symbol] ₓ and [symbol] _{y}. In addition, in this example, there is an assumption that all components of the kernel are bounded-input bounded-output (BIBO) stable. Therefore, the component filters belong to the filter kernel space H= [symbol] ¹( [symbol] ).

In this example, for every neuron i, each color channel uₘ(x, y, t)=1, . . . , 3, of the input signal u is independently filtered by the corresponding component hₘⁱ(x, y, t), of the receptive field hⁱ(x, y, t), yielding a temporal signal

vₘ^{t}(t)= [symbol] hₘⁱ(x,y,t−s)uₘ(x,y,s)dxdyds, m=1, 2, 3. (Equation 14)

The output of the three receptive field components (611, 613, 615 or 617, 619, 621 or 623, 625, 627) can then be summed (407) to provide an aggregate temporal input vⁱ(t) to the i th neuron 651, 653, 655 that amounts to

$${v}^{i} ( t ) = {\sum }_{m = 1}^{3} {v}_{m}^{i} ( t ) = {\sum }_{m = 1}^{3} ( {\int }_{𝔻} {h}_{m}^{i} ( x , y , t - s ) {u}_{m} ( x , y , s ) d x d y d s ) . \qquad ( Equation 15 )$$

In this example, the three-dimensional color visual stimulus u(x, y, t) 601 can be effectively transformed into a one-dimensional signal vⁱ(t) 671, 673, 675, in which colors, spatial and temporal attributes of u 601 are multiplexed. vⁱ 671, 673, 675 is then encoded by the i th neuron 641, 643, 645 into a spike train 651, 653, 655, with the sequence of spike times denoted by (tₖⁱ)_{keZ} where k is the index of the spike. In this example, the summation 631, 633, 635 can be justified because in a retina, the response of many neurons can be captured by a linear combination of the cone signals.

FIG. 7 illustrates an exemplary block diagram of an Integrate-and-fire (IAF) neuron in accordance with the disclosed subject matter. An Integrate-and-Fire neuron illustrated in FIG. 7 can time encode a stimulus signal by transforming it into a sequence of time events or spikes. As illustrated in FIG. 7, the input v together with an additive bias b are passed through an integrator with integration constant C. After thresholding, a spike is generated that resets the integrator.

In this example, for simplicity, it can be assumed that each point neuron 651, 653, 655 is an Integrate-and-Fire (IAF) neuron 651, 653, 655 as illustrated in FIG. 7. However, many other point neuron models, including conductance-based models threshold-and-fire neurons and oscillators with both multiplicative and additive coupling, or the like can be used.

The IAF neuron i, illustrated in FIG. 7, can encode its input vⁱ into the sequence of spike times tₖⁱ

$${\int }_{{t}_{k}^{i}}^{{t}_{k + 1}^{i}} {v}^{i} ( s ) d s = {q}_{k}^{i} , k ∈ ℤ , \qquad ( Equation 16 )$$

where qₖⁱ=Cⁱδⁱ−bⁱ(tₖ₊₁ⁱ−tₖⁱ). Here, Cⁱ, δⁱ and bⁱ are the integration constant, threshold and bias, respectively, of the ith neuron. The encoding performed by the entire neural circuit can then be expressed by the following equations

$${\int }_{{t}_{k}^{i}}^{{t}_{k + 1}^{i}} {\sum }_{m = 1}^{3} ( {\int }_{𝔻} {h}_{m}^{i} ( x , y , t - s ) {u}_{m} ( x , y , s ) d x d y d s ) d t = {q}_{k}^{i} , \\ k ∈ ℤ , \qquad ( Equation 17 )$$

for all i=1, 2, . . . , N. By defining linear functionals [symbol] ₖⁱ: [symbol] ³→ [symbol] , i=1, 2, . . . , N, kε [symbol] , where

$${𝒯}_{k}^{i} u = {\int }_{{t}_{k}^{i}}^{{t}_{k + 1}^{i}} {\sum }_{m = 1}^{3} ( {\int }_{𝔻} {h}_{m}^{i} ( x , y , t - s ) {u}_{m} ( x , y , s ) d x d y d s ) d t , \qquad ( Equation 18 )$$

(Equation 17) can be rewritten as

Tₖⁱu=qₖⁱ. (Equation 19)

Called the t-transform, equation (19) above describes the mapping of the analog signal u 601 into a set of spikes (tₖⁱ), i=1, 2, . . . , N, kε [symbol] 651, 653, 655.

In this example, by combining signals from different channels 605, 607, 609, each neuron 641, 643, 645 can now carry different types of color information. For example, combining all three channels 605, 607, 609 can provide luminance of the video over a wide spectrum. Color opponency in the retina that typically takes the form of red versus green, blue versus yellow can be modeled as well.

The neural encoding circuit illustrated in FIG. 6 can be called the Color Video Time Encoding Machine (TEM) 199. In some examples, the Color Video TEM 199 can be equally interpreted as a Multiple-Input Multiple-Output (MIMO) neural encoder, where uₘ, m=1, 2, 3, are seen as three separate inputs. By modeling the color video as a single element in [symbol] ³, the fact that color is an intrinsic property of a natural visual stimulus can be highlighted.

In this example, the following Lemmas and proofs are made:

Lemma 1. The Color Video TEM 199 projects the stimulus u on the set of sampling functions

φₖⁱ=[φ_{1,k}ⁱ,φ_{2,k}ⁱ,φ_{3,k}ⁱ]^{T} with φ_{m,k}ⁱ=Tₖⁱ K̅_̅{̅x̅,̅y̅,̅t̅}̅e̅ₘ̅, m=1,2,3, and

[symbol]

u,φₖⁱ [symbol] =qₖⁱ, i=1,2, . . . , N, Kε [symbol] (Equation 20)

Proof: By using the Riesz Representation Theorem, there can exist functions φₖⁱε [symbol] ³ such that for all uε [symbol] ³,

[symbol]

ₖⁱu= [symbol] u,φₖⁱ [symbol] ³, i=1,2, . . . N, kε [symbol] . (Equation 21)

and therefore, the encoding of the color video u 601 by the TEM 199 can be expressed as

[symbol]

u,φₖⁱ [symbol] ³=qₖⁱ, i=1,2, . . . , N, kε [symbol] .

The entries of sampling function φₖⁱ can be obtained by the reproducing property

φ_{m,k}ⁱ(x,y,t)= [symbol] φₖⁱ,K_{x,y,t}eₘ [symbol] = [symbol] = [symbol] ₖⁱ K̅_̅{̅x̅,̅y̅,̅t̅}̅e̅ₘ̅,̅ m=1,2,3. (Equation 22)

Thus, similar to monochrome video encoding, the encoding of the color video can have a simple geometrical interpretation as sampling of u 601 by a set of input dependent sampling functions 203 (coordinates) φₖⁱ, and the qₖⁱ, kε [symbol] , and the corresponding measurements. W. 205.

### Example 3

### Decoding Algorithms for Color Vision

### Time Decoding Machines for Color Vision

FIG. 8 illustrates an exemplary embodiment of a color video Time Decoding Machine in accordance with the disclosed subject matter. In this example, it is assumed that all the receptive fields 611, 613, 615, 617, 619, 621, 623, 625, 627 and parameters of the neurons are known, the decoding algorithm reconstructs the video u 601 from the set of N spike trains (tₖⁱ4), i=1, 2, . . . , N, k=1, 2, . . . , nⁱ, 651, 653, 655 produced by the encoding neural circuit, where nⁱ is the number of spikes generated by neuron i 641, 643, 645.

With reference to FIG. 8, given the assumption that uε [symbol] ³, and the fact that encoding of the video can consist of projections of u 601 onto a set of sampling functions, the reconstruction 213 of the encoded video can be formulated as the spline interpolation problem

$$\hat{u} = \begin{matrix}argmin \\ u ∈ {ℋ}^{3} , {\{ {𝒯}_{k}^{i} u = {q}_{k}^{i} \}}_{k = 1 , … , {n}^{i}}^{i = 1 , … N}\end{matrix} \{ {‖ u ‖}_{{ℋ}^{3}}^{2} \} . \qquad ( Equation 23 )$$

In this example, the following theorems are used:

Theorem 1. Let the color video uε [symbol] ³ be encoded by the color Video TEM 199 with N neurons 651, 653, 655, all having linearly independent receptive fields 611, 613, 615, 617, 619, 621, 623, 625, 627. The color video can be reconstructed as

$$\hat{u} = {\sum }_{i = 1}^{N} {\sum }_{k = 1}^{{n}^{i}} {c}_{k}^{i} {φ}_{k}^{i} , \qquad ( Equation 24 )$$

where the cₖⁱ's 209 are the solution to the system of linear equations (where q is the measurements 205)

Φc=q, (Equation 25)

c[c₁¹, c₂¹, . . . , cₙ_{¹}¹, . . . , c₁^{N}, c₂^{N}, . . . , cₙ_{^{N}}^{N}]^{T}, q=[q₁¹, q₂¹, . . . , qₙ_{¹}¹, . . . , q₁^{N}, q₂^{N}, . . . , qₙ_{^{N}}^{N}]^{T}, and Φ is the block matrix

Φ=[Φ^{ij}], (Equation 26)

where i, j=1, 2, . . . N and the block entries are given by

[Φ^{ij}]ₖₗ= [symbol] φₖⁱ,φₗ^{j} [symbol] , for all i,j=1,2, . . . , N and k=1,2, . . . , nⁱ, l=1,2, . . . , n^{j} (Equation 26.5)

Proof: The form of the solution (Equation 24) is given by the well-known Representer Theorem. Substituting the solution into (Equation 23), the coefficients cₖⁱ 209 can be obtained by solving the constraint optimization problem

minimize ½c^{T}Φc,

subject to Φc=q (Equation 27)

whose solution is just the solution to Φc=q.

Remark 1. Since [symbol] ³ is finite-dimensional, solution to (Equation 23) can also be formulated using the basis representation of u in (Equation 1). The two approaches are equivalent in the absence of noise. However, the solution in Theorem 1 can be easily extended to an infinite dimensional space, since the reconstruction û is in the subspace generated by the span of the set of sampling functions (φₖⁱ). Moreover, rather than being complex (due to the complex basis representation), the optimization problem of Theorem 1 is real valued. It can be solved by a simple recursive algorithm instead of using a pseudo-inverse, and can be implemented efficiently on parallel hardware such as graphical processing units (GPUs).

Remark 2. A sufficient condition for perfect reconstruction for any uε [symbol] ³ is that the set of sampling functions generated in the encoding of u must span [symbol] ³. Since the spatial dimension of the sampling functions is completely determined by the receptive fields, it is necessary to have at least 3(2Lₓ+1)(2L_{y}+1) filters to span the spatial dimensions. This sets a lower bound on the number of neurons for perfect reconstruction. Additionally, it is necessary to have a total number of measurements that is greater than 3(2Lₓ+1)(2L_{y}+1)(2Lₜ+1)+N in order for φₖⁱ to span the whole space. This also indicates that if the spikes are relatively spaced, (2Lₜ+1) measurements from one neuron already carry maximum temporal information.

The Video TEM disclosed in the subject matter herein can be extended to deal with color videos. The disclosed subject matter, under the framework of RKHSs, can be used for encoding of color videos and their decoding can be formulated in similar fashion as gray-scale videos. Therefore, its extension to noisy case is also straightforward, for example, by considering regularization when IAF neurons have random thresholds.

### Example 4

### Evaluating Massively Parallel TDM Algorithms for Color Vision

This example illustrates an exemplary way of encoding and decoding of a color video sequence. FIG. 9 illustrates an exemplary snapshot of the original color video 901 and reconstructed video 903 in accordance with the disclosed subject matter. As illustrated in FIG. 9, the snapshot of the original video 901 is shown on the left, which shows a bee on a sunflower. The reconstruction 903 is shown in the middle and the error 905 on the right. The error 905 can be seen to be fairly small.

In this example, the stimulus is a 10 [s], 160 [px]×90 [px] natural color video. The video is encoded by a massively parallel neural circuit with 30,000 color-component receptive fields in cascade with IAF neurons. Each receptive field component has a profile modeled as a spatial Gabor function derived from the mother function

$$D ( x , y , φ ) = \frac{1}{\sqrt{2 π}} exp ( - \frac{{x}^{2}}{2} - \frac{{y}^{2}}{8} ) cos ( - 2.5 x + φ ) ,$$

with translations

[symbol]

₍ₓ_{₀}_{,y}_{₀}₎D(x,y,φ)=D(x−x₀,y−y₀,φ),

dilations

$${𝒟}_{α} D ( x , y , φ ) = \frac{1}{α} D ( \frac{1}{α} x , \frac{1}{α} y , φ ) ,$$

and rotations

[symbol]

_{θ}D(x,y,φ)=D(cos(θ)x+sin(θ)y,−sin(θ)x+cos(θ)y,φ).

In this example, an initial orientation θₘⁱ and phase φₘⁱ picked from a uniform distribution [0,2π) is considered, as well as two levels of dilation αₘⁱε{2^{0.5},2^{1.5}}, with probability 0.8 and 0.2, respectively. The center coordinates of the red-component receptive fields (x₀ⁱ, y₀ⁱ) are picked randomly from a uniform distribution. The center coordinates of green- and blue-component receptive fields are picked around the red-component center with Gaussian distributions [symbol] (x₀ⁱ,1) and [symbol] (y₀ⁱ, 1).

In this example, to create a non-separable spatio-temporal receptive field, a temporal component is introduced by making all of the Gabor functions rotate at an angular speed v=2.5π(rad/s) around their respective centers (xₘⁱ, yₘⁱ). Furthermore, the temporal dynamics is modulated by a raised cosine function

$$f ( t ) = \{ \begin{matrix}1 - cos ( 2 π \cdot 10 \cdot t ) , & 0 \leq t \leq 0.1 [ s ] \\ 0 , & otherwise\end{matrix} \qquad ( Equation 32 )$$

to ensure that the spatiotemporal receptive field is causal in the time variable and has a finite memory.
The overall receptive field can be expressed as

hₘⁱ(x,y,t)=f(t) [symbol] ₓ_{ₘ}_{ⁱ}_{y}_{ₘ}_{ⁱ} [symbol] _{α}_{ₘ}_{ⁱ} [symbol] _{θ}_{ₘ}_{ⁱ}_{+2.5πt}D(x,y,φₘⁱ) (Equation 34)

In this example, with reference to FIG. 7, the bias, threshold and integration constant of all IAF neurons are picked to be the same, and they are b=3, δ=0.1, and κ=1, respectively.

In reconstruction, a spatio-temporal stitching algorithm is deployed. The entire screen is divided into 4 overlapping parts and time is cut into 150 [ms] slices. Each part is of size 56 [px]×90 [px]. The stitching volume then becomes 56 [px]×90 [px]×0.15 [s]. In this example, the orders of the space are picked to be Lₓ=24, L_{y}=36, Lₜ=8, Ωₓ=Ω_{y}=0.375·2π and Ωₜ=10·2π so that the overall period of the space is larger than each of the volumes. This is done in order to embed a typically non-periodic natural stimulus into a periodic space. It is also noticed that, in practice, the rotations of Gabor filters cover the spatial frequency in a certain radius. Therefore, the bandwidth they cover is isotropic in every direction. To accommodate this fact, lₓ and l_{y} is restricted to be in the set {(lₓ,l_{y})|lₓ²L_{y}²+l_{y}²Lₓ²≦Lₓ²L_{y}²}. In the rest of the examples disclosed herein, if not mentioned explicitly, this circular bandwidth profile is considered when specifying the order of the space Lₓ and L_{y}.

In this example, the total number of spikes produced in encoding is 9,001,700 for a duration of 10 seconds. Each volume is typically reconstructed from about 90,000 measurement. A snapshot of the original color video and the reconstructed video is seen in FIG. 9.

As illustrated in FIG. 9, the snapshot of the original video 901 is shown on the left, which shows a bee on a sunflower. The reconstruction 903 is shown in the middle and the error 905 on the right. The error 905 can be seen to be fairly small.

In this example, the signal-to-noise ratio (SNR) of the reconstruction is 30.71 dB. The structural similarity (SSIM) index of the reconstruction is 0.988. In addition, each color component can be individually accessed. FIG. 10 illustrates an exemplary snapshot of all three channels of the corresponding time instant in FIG. 9 in accordance with the disclosed subject matter. As illustrated in FIG. 10, 1001 is the snapshot of the red channel. As further illustrated in FIG. 10, 1003 is the snapshot of the green channel and 1005 is the snapshot of the blue channel. FIG. 10 further illustrates a snapshot of the original videos in each color channel and the reconstructed video. From left to right are respectively, the original video 1007, reconstructed color video 1009 and the error 1010. Each color channel is a gray-scale image, but is pseudo-colored to indicate their respective channels.

Since the original video is a natural video and is not strictly in the RKHS, the video was not reconstructed perfectly. However, it is still decoded with very high quality.

In this example, the periods Tₓ, T_{y}, tₜ defined in the reconstruction space is larger than the size and duration of the stitching volume. In this example, by embedding the stitching volume in a larger periodic space, the reconstruction no longer has to be periodic. This can provide for the reconstruction of natural stimuli and the choice of space flexible. Despite the fact that the dimension of the space can be larger, it does not necessarily impose a much larger condition for number of spikes needed to reconstruct the stimulus. This can be due to the fact that the sampling functions only need to span a subspace that the stitching volume is associated with. For example, in the reconstruction above, the space of choice is of dimension 137,751 (2701×(2Lₜ+1)×3, where 2701 is the space dimension), but only some 90,000 measurements can already yield high quality reconstruction. In this example, the temporal period is Tₜ=0.8 s, while the duration of the stitching volume is only 0.15 s. Therefore, the stitching volume can be well restricted in a period of 0.4 s. This is a subspace with Lₜ=4 having dimension 72927.

### Example 5

### Identification of Neural Encoding Circuits for Color Vision

### Channel Identification Machines for Color Vision

In this example, the color video encoded by the Color Video TEM can be reconstructed, given the spike times produced by a population of neurons and the parameters of each of the neurons. However, in some cases, the parameters of the neurons are not necessarily available apriori and need to be identified. In this scenario, the neurons can typically be presented with one or more input test stimuli and their response, or output, is recorded so that neuron parameters can be identified using the input/output data. The identification problems of this kind are mathematically dual to the decoding problem discussed above. Specifically, information about both the receptive fields and the spike generation mechanism can be faithfully encoded in the spike train of a neuron.

In this example, spike times can be viewed as signatures of the entire system, and under appropriate conditions, these signatures can be used to identify both the receptive fields and the parameters of point neurons. In this example, the key experimental insight is that the totality of spikes produced by a single neuron in N experimental trials can be treated as a single multidimensional spike train of a population of N neurons encoding fixed attributes of the neural circuit. Furthermore, in this example, it can be proven that only a projection of the neural circuit parameters onto the input stimulus space can be identified. The projection is determined by the particular choice of stimuli used during experiments and under natural conditions it converges to the underlying parameters of the circuit.

In this example, massively parallel neural circuits are used to process (color) visual stimuli. It should be understood that massively parallel neural circuits can be a circuit that includes one or more neurons and where the neurons encode the color signals in parallel. For clarity, this example considers identification of receptive fields only. Identification of spike generation parameters and/or connectivity between the neurons can be handled similarly to the disclosed subject matter herein.

This example considers the identification of a single receptive field associated with only one neuron, since identification of multiple receptive fields for a population of neurons can be performed in a serial fashion. This example, therefore, drops the superscript

i in hₘⁱ and denote the m-th kernel component by hₘ. Moreover, this example introduces the natural notion of performing multiple experimental trials and use the same superscript i to index stimuli on different trials i=1, . . . , N. In what follows the neural circuit referred to as the Color Video TEM consists of a color receptive field h=(h₁,h₂,h₃)^{T} in cascade with a single IAF neuron.

In this example, the following definitions are used:

Definition 1. A signal uⁱ, at the input to a Color Video TEM together with the resulting output [symbol] ⁱ=(tₖⁱ [symbol] is called an input/output (I/O) pair and is denoted by (uⁱ, [symbol] ⁱ).

Definition 2. The operator [symbol] : H→ [symbol] ³, where H is the space of absolute integrable functions on [symbol] , i.e., [symbol] ₁ ( [symbol] ), with elements ( [symbol] h)ₘ, m=1, 2, 3 given by

$${( 𝒫 h )}_{m} ( x , y , t ) = \frac{1}{{T}_{x} {T}_{y} {T}_{t}} {\int }_{𝔻} {h}_{m} ( {x}^{′} , {y}^{′} , {t}^{′} ) {K}_{m} ( x , y , t ; {x}^{′} , {y}^{′} , {t}^{′} ) d {x}^{′} d {y}^{′} d {t}^{′} ,$$

which can be called the projection operator.
(Equation 35)

Consider a single neuron receiving a stimulus uε [symbol] ³, i=1, 2, . . . , N. The aggregate output vⁱ=vⁱ(t), tε [symbol] ₜ, of the receptive field h produced in response to the stimulus uⁱ during the trial i is given by

$${v}^{i} ( t ) = {\sum }_{m = 1}^{3} {\int }_{𝔻} {h}_{m} ( x , y , t - s ) {u}_{m}^{i} ( x , y , s ) d x d y d s , \qquad ( Equation 36 )$$

where each signal uₘⁱ is an element of the space [symbol] . Since [symbol] is an RKHS, by the reproducing property, uₘⁱ(x, y, t)= [symbol] uₘⁱ,K_{x,y,t}eₘ [symbol] . It follows that the mth term of the sum in (Equation 36) can be written as

$${\int }_{𝔻} {h}_{m} ( x , y , t - s ) {u}_{m}^{i} ( x , y , s ) d s d x d y == {\int }_{𝔻} {h}_{m} ( x , y , s ) {u}_{m}^{i} ( x , y , t - s ) d x d y d s = {=}^{( a )} {\int }_{𝔻} {h}_{m} ( x , y , s ) \frac{1}{{T}_{x} {T}_{y} {T}_{t}} {\int }_{𝔻} {u}_{m}^{i} ( {x}^{′} , {y}^{′} , {t}^{′} ) {K}_{m} ( x , y , t - s ; {x}^{′} , {y}^{′} , {t}^{′} ) d {x}^{′} d {y}^{′} d {t}^{′} d x d y d s {=}^{( b )} {\int }_{𝔻} {u}_{m}^{i} ( {x}^{′} , {y}^{′} , {t}^{′} ) \frac{1}{{T}_{x} {T}_{y} {T}_{t}} {\int }_{𝔻} {h}_{m} ( x , y , s ) {K}_{m} ( {x}^{′} , {y}^{′} , {t}^{′} - {t}^{′} ; x , y , s ) d x d y d s d {x}^{′} d {y}^{′} d {t}^{′} {=}^{( c )} {\int }_{𝔻} {u}_{m}^{i} ( {x}^{′} , {y}^{′} , {t}^{′} ) {( 𝒫 h )}_{m} ( {x}^{′} , {y}^{′} , t - {t}^{′} ) d {x}^{′} d {y}^{′} d {t}^{′} = {\int }_{𝔻} {u}_{m}^{i} ( {x}^{′} , {y}^{′} , t - {t}^{′} ) {( 𝒫 h )}_{m} ( {x}^{′} , {y}^{′} , {t}^{′} ) d {x}^{′} d {y}^{′} d {t}^{′} \qquad ( Equation 37 )$$

where ^{(a)} follows from the reproducing property of the kernel Kₘ, ^{(b)} from the symmetry of Kₘ, ^{(b)} from the symmetry of Kₘ and the fact that Kₘ(x, y, t; x′, y′, t′) can be simplified as Kₘ(x−x′, y−y′, t−t′) by abuse of notation (see (5)) and ^{(c)} from Definition 2. Thus, the Color Video TEM is described by the set of equations:

[symbol]

ₖⁱ[ [symbol] h]=qₖⁱ, kε [symbol] , i=1, . . . , N, (Equation 38)

where the transformations [symbol] ₖⁱ: [symbol] ³→ [symbol] are linear functionals given by

$${ℒ}_{k}^{i} [ 𝒫 h ] = {\int }_{{t}_{k}^{i}}^{{t}_{k + 1}^{i}} {\sum }_{m = 1}^{3} ( {\int }_{𝔻} {u}_{m}^{i} ( x , y , t - s ) {( 𝒫 h )}_{m} ( x , y , s ) d x d y d s ) d t ,$$

for all i=1, . . . , N, and kε [symbol] . Because [symbol] ₖⁱ is linear and bounded, (29) can be expressed in inner product form as

[symbol]

h,ψₖⁱ [symbol] =qₖⁱ, (Equation 39)

where and ωₖⁱ(x,y,t)=[ω_{l,k}ⁱ(x,y,t),ψ_{2,k}ⁱ(x,y,t),ψ_{3,5}ⁱ(x,y,t)]^{T} and

ψ_{m,k}ⁱ(x,y,t)= [symbol] ₖⁱ[ K̅e̅ₘ̅], m=1,2,3. (Equation 40)

Effectively, in this example, the problem has been turned around so that each inter-spike interval [tₖⁱ, tₖ₊₁ⁱ) produced by the IAF neuron on experimental trial i is treated as a quantal measurement qₖⁱ of the sum of the components of the receptive field h, and not the stimulus uⁱ. When considered together in this example, (Equation 38) and (Equation 19) can demonstrate that the identification problem can be converted into a neural encoding problem similar to the one discussed in the disclosed subject matter. In this example, however, that in (Equation 19) i denotes the neuron number whereas i in (Equation 38) denotes the trial number. FIG. 11 illustrated this concept. FIG. 11 illustrates an exemplary block diagram of functional identification with multiple trials of controlled videos in accordance with the disclosed subject matter. In FIG. 11, the same neuron is stimulated with N visual stimuli.

The important difference is that the spike trains produced by a Color Video TEM in response to test stimuli uⁱ, i=1, . . . , N, carry only partial information about the underlying receptive field h. Intuitively, the information content is determined by how well the test stimuli explore the system. More formally, given test stimuli uⁱε [symbol] ³, i=1, . . . , N, the original receptive field h is projected onto the space [symbol] ³ and only that projection [symbol] h is encoded in the neural circuit output. It follows from (Equation 39) the projection [symbol] h can be identified from measurements qₖⁱ, i=1, . . . , N, kε [symbol] .

The following example now provides an algorithm, called the Color Video Channel Identification Machine (Color Video CIM), to functionally identify a neural circuit. As discussed above, this algorithm can be considered the dual the decoding algorithm for color video.

In this example, the following theorems can be used.

Theorem 2. {uⁱ|uⁱε [symbol] ³}ᵢ₌₁^{N} be a collection of N linearly independent stimuli at the input to a Color Video TEM with a receptive field h. The projection of the receptive field [symbol] h, can perfectly be identified from a collection of I/O pairs {uⁱ, [symbol] ⁱ}ᵢ₌₁^{N} as a solution to the spline interpolation problem.

$$\hat{𝒫 h} = \begin{matrix}argmin \\ 𝒫 h ∈ {ℋ}^{3} , {\{ {ℒ}_{k}^{i} h = {q}_{k}^{i} \}}_{k = 1 , … , {n}^{i}}^{i = 1 , … , N}\end{matrix} \{ {‖ 𝒫 h ‖}_{{ℋ}^{3}}^{2} \} .$$

The solution is

$$\hat{𝒫 h} = {\sum }_{i = 1}^{N} {\sum }_{k = 1}^{{n}^{i}} {c}_{k}^{i} {ψ}_{k}^{i} , \qquad ( Equation 41 )$$

where the cₖⁱ's satisfy the system of linear equations

φc=q, (Equation 42)

with c=[c₁¹, c₂¹, . . . , cₙ_{¹}¹, . . . , c₁^{N}, c₂^{N}, . . . , cₙ_{^{N}}^{N}]^{T} q=[q₁¹, q₂¹, . . . , q₁_{¹}¹, . . . , q₁^{N}, q₂^{N}, . . . , qₙ_{^{N}}^{N}]^{T}, and Φ is the block matrix.

Φ=[Φ^{ij}],

where i, j=1, 2, . . . , N, and the block entries are given by (see also Appendix 5)

[Φ^{ij}]ₖₗ= [symbol] ψₖⁱ,ψₗ^{j} [symbol] , for all i,j=1,2, . . . , N and k=1,2, . . . , nⁱ, l=1,2, . . . , n^{j} (Equation 43)

In this example, the necessary condition for identification is that the total number of spikes generated in response to all N trials is larger than 3(2Lₓ+1)(2L_{y}+1)(2Lₜ+1)+N. If the neuron produces v spikes on each trial i=1, . . . , N, of duration Tᵢ, then a sufficient condition is that the number of trials

$$N \geq \{ \begin{matrix}⌈ \frac{3 ( 2 {L}_{x} + 1 ) ( 2 {L}_{y} + 1 ) ( 2 {L}_{t} + 1 )}{v - 1} ⌉ , & v < 2 {L}_{t} + 2 \\ 3 ( 2 {L}_{x} + 1 ) ( 2 {L}_{y} + 1 ) , & v \geq 2 {L}_{t} + 2\end{matrix} , \qquad ( Equation 44 )$$

Proof: The proof is similar to that of Theorem 1.

Remark 3. In this example, it is emphasized that only the projection of h onto [symbol] ³ can be identified. In addition, the similarity of the identification algorithm and the decoding algorithm can be noted. This can be a direct result of the duality of the functional identification and decoding. Therefore, the two problems are highly related. Similar to decoding, a sufficient condition for perfect identification of any [symbol] hε [symbol] ³ is that the set of sampling functions {ψₖ^{ij}} span [symbol] ³. Therefore, it is necessary to have N≧3(2Lₓ+1)(2L_{y}+1) and a total of at least 3(2Lₓ+1)(2L_{y}+1)(2Lₜ+1)+N spikes.

### Example 6

### Evaluating Massively Parallel CIM Algorithms for Color Vision

An example of functional identification of a single non-separable spatio-temporal receptive field is next disclosed. One can use both natural video and artificially generated bandlimited noise to identify the receptive fields, and illustrate bounds for the number of video clips and number of spikes for perfect identification. A full-scale identification of the neural circuit can be performed by using a long sequence of continuous natural stimuli instead of small video clip segments.

In the first example, the neuron to be identified has a receptive field that resembles that of a Red-On-Green-Off (R+G−) midget cell in the primate retina. The red and green components of the receptive field are modeled as space-time separable functions. They are Gaussian functions spatially, and resemble biphasic linear filters temporally. The blue component is set to zero, but it will also be identified. The temporal span of the filter is 150 [ms] and spatially it is confined to a 32 [px]×32 [px] screen.

FIG. 12A and FIG. 12B illustrate an exemplary receptive field in accordance with the disclosed subject matter. FIG. 12A illustrates the snapshot of the receptive field at 40 ms. FIG. 12B illustrates a snapshot of the projection of the receptive field at 40 ms. At this time instant, the red component of the receptive field provides the excitatory center (red surface 1201) while the green component provides the inhibitory surround (green surface 1203).

In this example, to identify the receptive field, it is considered that Tₜ=300 ms, Tₓ=T_{y}=32. The following parameters are chosen in this example: Lₓ=L_{y}=6, Lₜ=12, Ωₓ=Ω_{y}=0.25π and Ωₜ=80π. The total dimension of the space is 113×(2Lₜ+1)×3=8,475. The projection of the receptive field [symbol] h is close to the underlying receptive field h itself (also illustrated in FIG. 12B). The SNR of the projection to the original filter is 23.12, where SNR is computed only for the red 1201 and green 1203 components. The identified filter is compared with the projection of the receptive field afterwards.

In this example, to identify the receptive field, N video clips are generated in the Hilbert space of interest by randomly picking coefficients for each basis. In addition, the video is real valued. By generating videos randomly, if N≦113×3=339, then their projections to the subspaces spanned by each set Sᵢₗ_{ₜ}={eₗ_{ₓ}ₗ_{_{y}}ₗ_{ₜ}|lₓ=−Lₓ, . . . , Lₓ, l_{y}=−L_{y}, . . . , L_{y}}, lₜ=−Lₜ, . . . , Lₜ are linearly independent with a high probability.
(Equation 45)

To illustrate the identification quality by using different number of spikes and number of video clips, the parameters of the IAF neuron can be artificially modified, but the underlying receptive field is kept the same. Note that the modification of parameters of the IAF neuron are not necessarily biologically plausible, but are used here in simulation for an exemplary illustration of the several bounds on number of measurements.

FIG. 13 A, FIG. 13B, and FIG. 13C illustrate exemplary effect of number of video clips and total number of measurements on the quality of identification in accordance with the disclosed subject matter. FIG. 13A illustrates effect on the quality of identification when fixed number of measurements (1301 represents 19 measurements, 1303 represents 25 measurements and 1305 represents 29 measurements) are used from each video clip. As further illustrated in FIG. 13A, the SNR increases as more video clips is used until saturation at either total number of measurements passes the dimension of the space (19 measurements 1301, 25 measurements 1303), or the number of video clips reaches (2Lₓ+1)(2L_{y}+1) (Equations 25-29). As illustrated in FIG. 13B, a fixed number of video clips is used in identification while number of measurements from each video clip increases. As illustrated in FIG. 13B, 1311 represents 180 measurements, 1309 represents 336 measurements, and 1307 represents 348 measurements. As illustrated in FIG. 13C, the number of video clips is varied while the total number of measurement remains fixed around 9,000.

In this example, first the number of video clips N is varied while using the same number of spikes generated by each of the N video clips. The SNR is illustrated in FIG. 13A. As further illustrated in FIG. 13A, all four curves follow a general trend: the SNR increases as more video clips are used until it saturates at around 60 [dB], which indicates perfect identification. Comparing among the four curves, it can be seen that as each video clip generates more spikes/measurements, the identification quality increases. However, the SNR cannot be further improved after the number of spikes for each video clip reaches (2Lₜ+1)+1=26 spikes. This is also illustrated in FIG. 13B, where the number of video clips if fixed while varying the number of measurements in each video clip. Furthermore, the cyan (1311) and black curve (1309) show that even if the total number of measurements is larger than the dimension of the space, perfect identification is not necessarily achieved if N<(2Lₓ+1)(2L_{y}+1). As illustrated in FIG. 13C, the number of video clips is varied while the total number of measurement remains fixed around 9,000. Identification for N≧342 illustrates the lower bound of videos/experiments need to be used in order to properly identify the receptive field. It is also noted that randomly generating video clips does not completely guarantee linear independence. Therefore, the bound for N is slightly shifted from 339.

To sum up, for the first example, the first example demonstrates two useful bounds for perfectly identifying the projection [symbol] h of a receptive field h onto a Hilbert space [symbol] ³. The first lower bound is that the total number of measurements can be greater or equal to the dimension of the space (2Lₓ+1)(2L_{y}+1)(2Lₜ+1). Equivalently, the totality of spikes produced in response to N experimental trials involving N different video clips can be greater than (2Lₓ+1)(2L_{y}+1)(2Lₜ+1)+N. The second lower bound is that the number of video clips N can be greater or equal to (2Lₓ+1)(2L_{y}+1). Both conditions can be satisfied at the same time. In addition, each video clip can provide a maximum of (2Lₜ+1) informative measurements towards the identification (see also Remark 3).

In this example, a long sequence of continuous natural video is considered in identifying the entire neural circuit. Colors in natural visual scenes can be much more correlated than in randomly generated bandlimited signals using the above procedure. As neural systems can be tuned to the natural statistics, it is likely that neurons will respond differently to natural stimuli. Thus, there can be a need to be able to accommodate the use of natural stimuli during functional identification in real experiments. The machinery of RKHS, and spaces of trigonometric polynomials specifically, provide that capability.

In this example, a sliding temporal window is used to create multiple video clips from a single continuous natural video. This is needed to fix one of the complications arising in using natural video with the introduced methodology, namely how to properly segment a long natural sequence into multiple segments of videos. Since the spatio-temporal receptive field has temporal memory of length S [symbol] supp (h), i.e., it can extend into the past, the timing of a spike at a time tₖ is affected by the stimulus on the time interval of length S preceding the spike, i.e., by values of the stimulus u(t) on tε[tₖ−S, tₖ]. Therefore, when recording spikes in response to a stimulus u(t), care should be taken so that the recording is longer than the temporal support of the receptive field and only those spikes occurring S seconds after the start of the recording are used.

FIG. 14A and FIG. 14B illustrate exemplary spikes in accordance with the disclosed subject matter. With reference to FIG. 14A, the valid spikes given a window size and filter size: The sliding window is of length Tₜ as the temporal period of the RKHS, shown as the blue window 1401, and the corresponding clip of the signal u(t) is highlighted by blue 1402. The filter h(t) has temporal support of S. The red and green spikes 1407 are all the spikes generated inside the time of the window, but only the spikes generated in the interval (S, Tₜ] (green 1407 spikes) can be used in identification and at the same time ensuring interference free from videos in the past, but the spikes generated in the interval [0,S] (red 1403 spikes) cannot. Phrased differently, if the window size is Tₜ and one uses spikes generated in the interval (R,Tₜ] in identification, then the identified receptive field is only valid if the temporal support of it is within [0, R]. The rest of the spikes (black spikes) are represented by 1405.

With reference to FIG. 14B, the sliding window size is chosen as 0.2 s and the step between windows is 0.1 s, where the color of the spikes indicates its use in the corresponding window. 1427 is the green window. 1425 are the green spikes. 1423 are the brown spikes and 1421 is the brown window. 1419 are the red spikes and 1415 is the red window. 1417 are the blue spikes and 1413 is the blue window. 1411 are the magenta spikes and 1409 are the black spikes. Therefore, in this example, the spikes generated in the last 0.1 s of each clip is valid to identify a receptive field with temporal support of less than 0.1 s. Moreover, in this example, only a small number of measurements were discarded. Those are the spike intervals that contains multiples 0.1.

In examples below a custom natural video shot by a handheld device is used. The total length of the video is 200 seconds. This single video is used to identify the complete neural circuit, that is, the receptive fields of all N=30,000 neurons. Due to computational constraints and in the interest of time, each of the receptive field components hₘⁱ(x, y, t) are identified separately rather than the entire h^{t} This can easily be done by supplying a single color channel during the identification procedure.

In this example, for simplicity, it is assumed that the dilation parameter of the receptive field was known. For α=2^{0.5}, the chosen screen size is 24 [px]×24 [px], Ωₓ=Ω_{y}=0.5. For α=2^{1.5}, the chosen screen size is 48 [px]×48 [px] and Ωₓ=Ω_{y}=0.25. In both cases, Lₓ=L_{y}12, Lₜ=4 and Ωₜ=2π·20. The dimension of both spaces is 441×(2Lₜ+1)=3,969.

In this example, each neuron in the population has fixed but different parameters and generates about 100 spikes per second, or about 10=2Lₜ+2 spikes per windowed video clip. This choice of stimulus and neuron parameters allows each neuron to provide the maximum number of informative spikes about each video clip in the simulation. The number of spikes are varied and used in the identification. The number of video clips co-vary with the number of spikes as a result.

FIG. 15 illustrates an exemplary SNR of the identified receptive fields over the original receptive fields in accordance with the disclosed subject matter. As illustrated in FIG. 15, different colors are used to indicate a different number of total measurements used in the identification. Each dot is the SNR of identified receptive field for the corresponding neuron.

FIG. 15 illustrates a general trend that a larger number of measurements produces better identification. FIG. 15 further illustrates SNR of the 30000 identified filters. In FIG. 15, the color indicates the number of total measurements used in the identification for each receptive field. The average SNR is shown by dashed line for corresponding colors.

### Example 7

### Massively Parallel Neural Circuits for Stereoscopic Color Vision

In one example, the encoding, decoding, identification and its evaluation in the stimulus space for color videos discussed in the disclosed subject matter provided a basis for a few extensions to formulate video time encoding for multi-dimensional videos. Those extensions are reviewed in this example.

In this example, the current formulation of the encoding in a vector-valued RKHS also provides the flexibility to model videos that have a total of p components. A couple of examples include color videos defined with a different color scheme, and multiview videos that correspond to the same visual scene being sampled by more than one visual sensor. The extension to a [symbol] ^{p}-valued RKHS is straightforward, since the space of signals can be modeled as [symbol] ^{p}. This example discusses two applications based on different values of p.

### Example 7a

### Massively Parallel Neural Circuits for Stereoscopic Video

Stereoscopic videos can be two different streams of videos that are projected onto the left and right eyes. Typically, the two streams of videos are views of the same visual scene taken from slightly different angles. They arise naturally in the early visual system of vertebrates where binocular vision dominates. By combining multiple views of the visual scene, binocular vision provides for the extraction of the depth information about the visual scene.

FIG. 16 illustrates an exemplary block diagram of a massively parallel neural circuit for encoding stereoscopic video in accordance with the disclosed subject matter. As illustrated in FIG. 16, a massively parallel neural circuit for encoding monochrome (grayscale) stereoscopic video is seen. The input videos, denoted by (abuse of notation),

u(x,y,t)[u₁(x,y,t),u₂(x,y,t)]^{T}, (Equation 46)

can come from a single visual scene but are sensed by two eyes, where u₁ denotes the monochrome video sensed by the left eye and u₂ denotes that sensed by the right eye. In the visual cortex, the information from both eyes is combined in some neurons. This is modeled by the multi-component receptive fields hⁱ(x,y,t), where, by abuse of notation,

hⁱ(x,y,t)=[h₁^{t}(x,y,t),h₂ⁱ(x,y,t)]^{T}. (Equation 47)

In this example, each component hₘⁱ(x, y, t), m=1, 2, i=1, . . . , N, is assumed to be causal with finite support, and is BIBO stable. Each component receptive field performs a linear filtering operation on its corresponding input video before the outcomes are summed and fed into an IAF neuron. The above neural encoding circuit forms a Stereoscopic Video TEM.

An example is provided to demonstrate the encoding of stereoscopic videos and their reconstruction. The example of identification and the performance evaluation is omitted, since they will be similar to the case of color video.

In this example, the stereoscopic video has a view of 192 [px]×108 [px] in each component and was shot by two cameras calibrated to match binocular vision and provide a 3D visual perception [34]. Parameters of the space are Lₓ=72, L_{y}=40, Ωₓ=0.75π, Ω_{y}=0.74π, Lₜ=8 and Ωₜ=20π.

FIG. 17 illustrates an exemplary snapshot of the original video 1701, the reconstructed video 1703 and the error 1705 in accordance with the disclosed subject matter. As illustrated in FIG. 17, the 3D effects can be visualized by wearing red-cyan 3D glasses.

In this example, SNR of the reconstruction is 35.77 dB, SSIM index is 0.980. The reconstructions of separate eye channels are shown in FIG. 12.

FIG. 18 illustrates an exemplary snapshot of the original 1801 stereo video and the reconstructed 1803 in separate channels in accordance with the disclosed subject matter. The error is illustrated in 1805. As illustrated in FIG. 18, The left eye channel 1807 is shown in the top row and the right eye channel 1809 in the bottom row. From left to right are respectively, the original 1801 video, reconstructed 1803 video and the error 1805.

### Example 7b

### Massively Parallel Neural Circuits for Stereoscopic Color Video

FIG. 19 illustrates an exemplary blog diagram of a massively parallel neural circuit for encoding stereoscopic color video in accordance with the disclosed subject matter. The massively parallel neural circuits for color video and stereoscopic video can be combined to work with stereoscopic color video. The RKHS of interest then becomes [symbol] ⁶. In this example, neurons in the circuit can now encode information in all the color channels of both eyes.

The encoding, decoding and functional identification based on this circuit can be formulated similarly as described in the disclosed subject matter.

FIG. 20 illustrates an exemplary snapshot of the original 3D color video and the reconstructed in accordance with the disclosed subject matter. From left to right are respectively, the original video 2001, reconstructed 2003 color video and the error 2005. The 3D effects can be visualized by wearing red-cyan 3D glasses. The SNR of the reconstruction is 27.37 dB, SSIM index is 0.960.

FIG. 21 illustrates an exemplary reconstruction of individual channels in accordance with the disclosed subject matter. FIG. 21 illustrates a snapshot of the original 2101 stereo color video and the reconstructed 2103 in separate channels. The first three rows 2107 (red), 2109 (green), 2113 (blue) are the color channels in the left eye and the last three rows 2115 (red), 2117 (green), 2119 (blue) are the color channels in the right eye. From left to right are respectively, the original video 2101, reconstructed 2103 video and the error 2105.

### Example 8

### Neural Encoding of Color, Stereoscopic and a Mixture of Signals

In this example, TEMs, TDMs and CIMs have been derived for color and stereoscopic videos. A common feature of the encoding of all those videos is the use of multiple sensors to sense a single scene from different perspective and subsequently combining information from many channels. In the case of color video, the visual scene can be sensed by three color channels and neurons have the freedom to compare or compose multiple color. For stereoscopic video, the visual scene can be separately sensed by two horizontally displaced eyes and the representation in the neuron enables composition of signals from the two eyes.

Natural scenes are highly complex with variations in intensity, wavelength and geometry. In order to perceive the complexity of the visual world, visual system can chose to represent it by mixing information from many different aspects. The TEMs disclosed in the subject matter herein for stereoscopic color videos is one embodiment that can be used for such mixing.

In one example, the encoding with mixed signals can be important in the following ways. First, each of the channels represents one aspect of a visual scene. Information can be highly redundant across multiple channels. For example, all RGB channels can carry information about the form of objects in a visual scene, but at the same time, they are constrained by the form of the objects as well. A change in color intensity is more likely to happen at the boundary between two objects and this change can be reflected with high correlation across color channels. Combining information from multiple channels can provide a more compressed representation and require less information to be transmitted. The YUV or YCbCr video format, for example, has long been used in digital video technology where some of the components can be subsampled while keeping a similar perception. The disclosed subject matter can provide a framework for representing multiple channel information, for recovering the scene and for identifying of channel parameters, such that it can facilitate this reduction.

Second, the mixing of cone signal can be utilized as coordinate transformations in the color space jointly with space and time. This transformation can be useful in object recognition or in the separation of color and contrast information.

Third, mixing multiple channel signals can allow for multiple information being represented together and therefore enables readout of different aspects of the signals anywhere in the system. In other words, it can provide broadcast of multiple channels. Higher order systems can take the information as needed.

### Example 8

### Generalization to Infinite Dimensional RKHS

In one example, the scalar-valued RKHS disclosed in one embodiment of the subject matter herein, is the space of trigonometric polynomials. The finite dimensionality of this space can allow one to derive bounds on the number of spikes and number of neurons/trials for perfect reconstruction/identification. The structure of the space can also enabled the use of faster algorithms to perform decoding and identification. However, the choice of the base RKHS is flexible and does not exclude infinite dimensional spaces, and the formulation of decoding and functional identification by variational approach is readily applicable to deal with infinite dimensional space as well. While bounds on number of spikes can no longer be appropriate, the interpretation of the interpolation spline algorithm can still be powerful: the reconstruction is still generated by the subspace spanned by the finite number of sampling functions. That is, based on the observations in the sampling stage.

### Example 9

### Computation of the Φ Matrix

In this example, the entries for matrix Φ in Equation 25 are computed. This can be used by 207 in FIG. 2. As noted in Equation 22, that φ_{i,k}^{j}(x₁, x₂, t) amounts to:

$$\begin{matrix}= {\int }_{{t}_{k}^{j}}^{{t}_{k + 1}^{j}} ( {\int }_{𝔻} {h}_{i}^{j} ( {x}^{′} , {y}^{′} , s - {t}^{′} ) {K}_{i} ( x , y , t ; {x}^{′} , {y}^{′} , {t}^{′} ) d {x}^{′} d {y}^{′} d {t}^{′} ) d s & ( Equation 48 ) \\ = {\int }_{{t}_{k}^{k}}^{{t}_{k + 1}^{j}} ( {\int }_{𝔻} {h}_{i}^{j} ( {x}^{′} , {y}^{′} , {t}^{′} ) {K}_{i} ( x , y , t ; {x}^{′} , {y}^{′} , s - {t}^{′} ) d {x}^{′} d {y}^{′} d {t}^{′} ) d s & ( Equation 49 \\ = {\sum }_{{l}_{x} = - {L}_{x}}^{{L}_{x}} {\sum }_{{l}_{y} = - {L}_{y}}^{{L}_{x}} {\sum }_{{l}_{t} = - {L}_{t}}^{{L}_{t}} {\int }_{{t}_{k}^{j}}^{{t}_{k + 1}^{j}} ( {\int }_{𝔻} {h}_{i}^{j} ( {x}^{′} , {y}^{′} , {t}^{′} ) {e}_{{l}_{x} , {l}_{y} , {l}_{t}} ( x - {x}^{′} , x - {y}^{′} , t + {t}^{′} - s ) d {x}^{′} d {y}^{′} d {t}^{′} ) d s \\ = {\sum }_{{l}_{x} = - {L}_{x}}^{{L}_{x}} {\sum }_{{l}_{y} = - {L}_{y}}^{{L}_{y}} {\sum }_{{l}_{t} = - {L}_{t}}^{{L}_{t}} {e}_{{l}_{1} , {l}_{2} , {l}_{t}} ( x , y , t ) {\int }_{{t}_{k}^{j}}^{{t}_{k + 1}^{j}} ( {\int }_{𝔻} {h}_{i}^{j} ( {x}^{′} , {y}^{′} , {t}^{′} ) {e}_{- {l}_{x} , - {l}_{y} , - {l}_{t}} ( {x}^{′} , {y}^{′} , s - {t}^{′} ) d {x}^{′} d {y}^{′} d {t}^{′} ) d s \\ = {\sum }_{{l}_{x} = - {L}_{x}}^{{L}_{x}} {\sum }_{{l}_{y} = - {L}_{y}}^{{L}_{y}} {\sum }_{{l}_{t} = - {L}_{t}}^{{L}_{t}} {e}_{{l}_{x} , {l}_{y} , {l}_{t}} ( x , y , t ) {\int }_{{t}_{k}^{j}}^{{t}_{k + 1}^{j}} e - {l}_{t} ( s ) d s {\int }_{𝔻} {h}_{i}^{j} ( {x}^{′} , {y}^{′} , {t}^{′} ) {e}_{- {l}_{x} , - {l}_{y} , {l}_{t}} ( {x}^{′} , {y}^{′} , {t}^{′} ) d {x}^{′} d {y}^{′} d {t}^{′} . & ( Equation 50 )\end{matrix}$$

Since the eₗ_{ₓ}_{,l}_{ₓ}_{,l}_{ₜ}(x, y,t)'s form the orthonormal base in [symbol] , we see that

$${φ}_{i , k}^{j} ( x , y , t ) = {\sum }_{{l}_{x} = - {L}_{x}}^{{L}_{x}} {\sum }_{{l}_{y} = - {L}_{y}}^{{L}_{y}} {\sum }_{{l}_{t} = - {L}_{t}}^{{L}_{t}} {a}_{i , k , {l}_{x} , {l}_{t}}^{j} {e}_{{l}_{x} , {l}_{y} , {l}_{t}} ( x , y , t ) , \qquad ( Equation 51 )$$

where a_{i,k,l}_{ₓ}_{,l}_{_{y}}_{,l}_{ₜ}^{j} are the coefficients of the linear combination of bases and

$$\begin{matrix}{a}_{ik , {l}_{x} , {l}_{y} , {l}_{t}}^{j} = {\int }_{{t}_{k}^{j}}^{{t}_{k + 1}^{j}} {e}_{- {l}_{t}} ( s ) d s \cdot {\int }_{𝔻} {h}_{i}^{j} ( {x}^{′} , {y}^{i} , {t}^{′} ) {e}_{- {l}_{x} , - {l}_{y} , {l}_{t}} ( {x}^{′} , {y}^{′} , {t}^{′} ) d {x}^{′} d {y}^{′} d {t}^{′} \\ or & ( Equation 52 ) \\ {a}_{i , k , {l}_{x} , {l}_{y} , - {l}_{t}}^{j} = ( {\int }_{{t}_{k}^{j}}^{{t}_{k + 1}^{j}} {e}_{{l}_{t}} ( s ) d s ) ( {\int }_{𝔻} {h}_{i}^{j} ( {x}^{′} , {y}^{i} , {t}^{′} ) {e}_{- {l}_{x} , - {l}_{y} , - {l}_{t}} ( {x}^{′} , {y}^{′} , {t}^{′} ) d {x}^{′} d {y}^{′} d {t}^{′} ) \\ Let & ( Equation 53 ) \\ {h}_{i , {l}_{x} , {l}_{y} , {l}_{t}}^{j} = {\int }_{𝔻} {h}_{i}^{j} ( {x}^{′} , {y}^{i} , {t}^{′} ) {e}_{- {l}_{x} , - {l}_{y} , - {l}_{t}} ( {x}^{′} , {y}^{i} , {t}^{′} ) d {x}^{′} d {y}^{′} d {t}^{′} \\ we have & ( Equation 54 ) \\ {a}_{i , k , {l}_{x} , {l}_{y} , {l}_{t}}^{j} = \{ \begin{matrix}( {t}_{k + 1}^{j} - {t}_{k}^{j} ) {h}_{{il}_{x} , {l}_{y} , - {l}_{t}} & {l}_{t} = 0 \\ \frac{j {L}_{t}}{{Ω}_{t} {l}_{t}} ( {e}_{- {l}_{t}} ( {t}_{k + 1} ) - {e}_{- {l}_{t}} ( {t}_{k} ) ) {h}_{{il}_{x} , {l}_{u} , - {l}_{t} ,} & {l}_{t} \neq 0\end{matrix} & ( Equation 55 )\end{matrix}$$

The computation of the coefficients in (Equation 54) can be simplified by considering the space-time domain D to be exactly one period of the function in [symbol] , and by numerically evaluating the integral in the second half of (Equation 53) using the rectangular rule with uniform grid. Since the result is closely related to the 3D-DFT coefficients of hᵢ^{j}(x, y, t) these coefficients can be very efficiently obtained. Note also that the a_{i,k,l}_{ₓ}_{,l}_{_{y}}_{,l}_{ₜ}^{j} clearly depends on the particular neuron model and the spatio-temporal receptive field used in the encoding. (Equation 53) shows, however, that this dependency can easily be separated into two terms. The term in the first parenthesis depends only on the IAF neuron and the term in the second parenthesis depends only on the receptive field. Therefore,

$$\begin{matrix}{[ {Φ}^{ij} ]}_{kl} = {〈 {φ}_{k}^{i} , {φ}_{l}^{j} 〉}_{{ℋ}^{3}} \\ = {\sum }_{m = 1}^{3} {〈 {φ}_{m , k}^{i} , {φ}_{m , l}^{j} 〉}_{ℋ} \\ = {\sum }_{m = 1}^{3} {\sum }_{{l}_{x} = - {L}_{x}}^{{L}_{x}} {\sum }_{{l}_{y} = - Ly}^{{L}_{y}} {\sum }_{{l}_{t} = - {l}_{t}}^{{l}_{t}} {a}_{m , k , {l}_{x} , {l}_{y} , {l}_{t}}^{i} \overline{{a}_{m , l , {l}_{x} , {l}_{y} , {l}_{t}}^{j}} .\end{matrix} \qquad ( Equation 56 )$$

The disclosed subject matter can be implemented in hardware or software, or a combination of both. Any of the methods described herein can be performed using software including computer-executable instructions stored on one or more computer-readable media (e.g., communication media, storage media, tangible media, or the like). Furthermore, any intermediate or final results of the disclosed methods can be stored on one or more computer-readable media. Any such software can be executed on a single computer, on a networked computer (for example, via the Internet, a wide-area network, a local-area network, a client-server network, or other such network), a set of computers, a grid, or the like. It should be understood that the disclosed technology is not limited to any specific computer language, program, or computer. For instance, a wide variety of commercially available computer languages, programs, and computers can be used.

A number of embodiments of the disclosed subject matter have been described. Nevertheless, it will be understood that various modifications can be made without departing from the spirit and scope of the disclosed subject matter. Accordingly, other embodiments are within the scope of the claims.

We claim:

1. A method for encoding one or more multi-component signals, comprising:
receiving the one or more multi-component signals;
separating the one or more multi-component signals into one or more channels;
filtering each of the one or more channels using one or more receptive field components;
determining the sum of the outputs of the one or more receptive field components and providing it to one or more neurons; and
encoding the output sum, at the one or more neurons, to provide one or more encoded signals.

2. The method of claim 1, wherein the multi-component signals comprise color signals, and wherein the separating further includes sampling the signals into one or more channels.

3. The method of claim 1, wherein the multi-component signals comprise color signals, and wherein the separating further includes modeling each of the one or more channels is modeled into one or more monochromatic signals.

4. The method of claim 3, wherein the modeling further comprises using vector-valued tri-variable trigonometric polynomial space.

5. The method of claim 1, wherein the multi-component signals comprise color signals, and wherein the filtering further includes correlating each of the one or more receptive fields with a color component from the one or more channels.

6. The method of claim 1, wherein the one or more encoded signals comprises one or more spike trains.

7. The method of claim 1, wherein the determining further comprising arranging the one or more receptive fields.

8. The method of claim 7, wherein for each of the one or more receptive fields, the arranging comprises:
assigning a non-zero value to the first component of one of the one or more receptive field components; and
assigning a zero value to the one or more receptive field components other than the first component.

9. The method of claim 7, wherein the arranging the one or more receptive fields comprises:
randomly choosing the one or more receptive fields.

10. A method for decoding one or more encoded signals, comprising:
receiving the one or more encoded signals;
modeling at least one encoding function corresponding to each of the one or more encoded signals as a sampling of the one or more encoded signals and providing a first output;
determining the form of reconstruction of one or more output signals using the first output; and
reconstructing the one or more output signals using the form of reconstruction.

11. The method of claim 10, wherein the one or more encoded signals comprise one or more spike trains.

12. The method of claim 10, wherein the modeling further comprises:
determining one or more sampling of the one or more encoded signals;
determining one or more measurements from time of the one or more encoded signals; and
determining one or more coefficients of linear combination.

13. The method of claim 12, wherein the determining one or more coefficients comprises determining a function of the one or more sampling of the one or more output signals and the one or more measurements.

14. The method of claim 10, wherein the reconstruction of the one or more output signals comprises determining a function of the one or more sampling of the one or more output signals and the one or more coefficients.

15. A method for identifying one or more unknown receptive field components, comprises:
receiving one or more known multi-component signals;
separating the one or more known multi-component signals into one or more channels;
filtering each of the one or more channels using one or more unknown receptive field components;
determining a sum of the one or more filtered unknown receptive field components and providing it to one or more neurons;
encoding the sum, at the one or more neurons, to provide one or more encoded signals; and
identifying the one or more unknown receptive field components using the one or more encoded signals.

16. The method of claim 15, wherein the identifying the one or more unknown receptive field components further comprises:
receiving the one or more encoded signals;
modeling at least one encoding function corresponding to each of the one or more encoded signals as a sampling of the one or more encoded signals and providing a first output;
determining a form of reconstruction of the one or more unknown receptive field components using the first output; and
reconstructing the one or more unknown receptive field components using the form of reconstruction.

17. A system for encoding one or more multi-component signals, comprising:
a first computing device having a processor and a memory thereon for the storage of executable instructions and data, wherein the instructions are executed to:
receiving the one or more multi-component signals;
separating the one or more multi-component signals into one or more channels;
filtering each of the one or more channels into one or more receptive field components;
determining the sum of the outputs of the one or more receptive field components and providing it to one or more neurons; and
encoding the output sum, at the one or more neurons, to provide one or more encoded signals.

18. The system of claim 17, further comprising arranging the one or more receptive fields.

19. The system of claim 18, wherein for each of the one or more receptive fields, the arranging comprises:
assigning a non-zero value to the first component of one of the one or more receptive field components; and
assigning a zero value to the one or more receptive field components other than the first component.

20. The system of claim 18, wherein the arranging the one or more receptive fields comprises:
choosing randomly the one or more receptive fields.
